(19) United States
(12) Patent Application Publication
(10) Pub. No.: US 2026/0290986 A1
(43) Pub. Date: Sep. 24, 2026

(54) BATTERY ASSEMBLY

(71) Applicant: LG ENERGY SOLUTION, LTD., Seoul (KR)

(72) Inventors: Sang-Yong LEE, Daejeon (KR); Hye-Mi JUNG, Daejeon (KR)

(73) Assignee: LG ENERGY SOLUTION, LTD., Seoul (KR)

(21) Appl. No.: 19/569,161

(22) Filed: Mar. 17, 2026

(30) Foreign Application Priority Data
Mar. 18, 2025 (KR) 10-2025-0034941
Mar. 10, 2026 (KR) 10-2026-0043183

(51) Int. Cl. H01M 50/293; H01M 50/24; H01M 50/249

(52) U.S. Cl. CPC H01M 50/293; H01M 50/24; H01M 50/249; H01M 2220/20

(57) ABSTRACT

A battery assembly according to one embodiment of the present disclosure includes: a plurality of battery cells stacked along one direction; and a barrier disposed between the plurality of battery cells. The barrier may include a base plate, and a first metal sheet inserted into the base plate.

### CROSS-REFERENCE TO RELATED APPLICATIONS

This application is based on and claims priority from Korean Patent Application No. 10-2025-0034941 filed on Mar 18, 2025, with the Korean Intellectual Property Office, and Korean Patent Application No. 10-2026-0043183, filed on Mar 10, 2026, with the Korean Intellectual Property Office, the disclosures of which are incorporated herein in their entirety by reference.

### TECHNICAL FIELD

The present disclosure relates to a battery assembly.

### BACKGROUND

As the demand for portable electronic products such as smartphones, tablet PCs, and smart watches significantly increases, and electric vehicles have become gradually widespread, research on the batteries mounted on these products including the electric vehicles, particularly, on the secondary batteries that are repeatedly chargeable and dischargeable, is actively being conducted.

Currently commercially available secondary batteries include nickel cadmium batteries, nickel hydrogen batteries, nickel zinc batteries, lithium secondary batteries, and the like. Among them, the lithium secondary batteries are subject to little memory effect compared to nickel-based secondary batteries, and thus are receiving a lot of attention due to advantages such as free charging/discharging, a very low self-discharge rate, and a high energy density.

The lithium secondary batteries mainly uses a lithium-based oxide and a carbon material as a positive electrode active material, and a negative electrode active material, respectively. The lithium secondary batteries include an electrode assembly, and an external material that seals and accommodates the electrode assembly with an electrolyte, that is, a battery case. In the electrode assembly, a positive electrode plate and a negative electrode plate, which are coated with the positive electrode active material and the negative electrode active material, respectively, are disposed with a separator interposed therebetween.

In general, according to the shape of the external material, the lithium secondary batteries may be classified into can-type secondary batteries, in which the electrode assembly is accommodated in a metal can, and pouch-type secondary batteries, in which the electrode assembly is housed in a pouch of an aluminum laminate sheet.

The secondary batteries have recently been widely used for driving or energy storage not only in small devices such as portable electronic devices, but also in medium- to large-sized devices such as electric vehicles and energy storage systems (ESSs). A plurality of such secondary batteries may be accommodated together in a module case while being electrically connected to each other, thereby constituting a single battery module. Here, each secondary battery included in the single battery module may be referred to as a battery cell. Then, multiple such battery modules may be connected to each other to constitute a battery pack.

However, when a plurality of battery modules are included inside the battery pack, and a plurality of battery cells are included in each battery module in this manner, there may be a vulnerability to a thermal chain reaction between battery modules or battery cells. For example, when an event such as thermal runaway occurs within one battery module, such thermal runaway needs to be suppressed from propagating to other battery modules or other battery cells. When thermal runaway propagation between battery modules or battery cells is not properly suppressed, there is a risk that an event occurring in a specific battery module or battery cell may cause a chain thermal reaction in other battery modules or other battery cells, thereby causing an explosion or a fire or increasing the scale of the chain thermal reaction thereof.

In particular, when an event such as thermal runaway occurs in one battery module, the gas, flames, and the like, may be randomly emitted to the outside. Here, when the emission of gas or flames is not properly controlled, there is a risk that the gas or flames may be emitted toward other battery modules, thereby causing a thermal chain reaction in other battery modules. In particular, on the front side of the battery module, a module terminal exists, and then there may be a configuration for electrical connection to another battery module or another battery pack, that is, a module busbar. Therefore, when flames are emitted to the front side of such a battery module, the module terminal may be damaged in the battery pack and an electrical short may be caused. Also, since another battery module may be present on the front side of the battery module, when flames are emitted to the front side of a specific battery module, the emitted flames may be directed to the other battery module, thereby easily causing fire propagation between battery modules.

When thermal propagation occurring between battery modules or battery cells is not properly controlled, a voltage drop may rapidly occur in the battery module or the battery pack. Then, this may lead to a sudden shutdown of a device equipped with the battery module or the battery pack, thereby causing an unexpected damage. For example, when a voltage drop of a battery pack suddenly occurs during operation of an electric vehicle, it is not possible to ensure enough time to move the electric vehicle to a safe location.

Furthermore, when a fire or an explosion suddenly occurs because thermal propagation between battery modules or battery cells is not properly controlled, there is a high possibility of casualties among the users. For example, when thermal runaway occurs in an electric vehicle, occupants may not be able to safely escape when a sufficient amount of time is not secured before the fire is fully developed.

### SUMMARY

The present disclosure provides a battery assembly capable of suppressing propagation of a thermal event.

The present disclosure provides a battery assembly with improved thermal safety.

The present disclosure provides a battery assembly including a barrier with improved thermal insulation performance.

The present disclosure provides a battery assembly including a barrier with improved fire resistance performance.

The present disclosure provides a battery assembly including a barrier with improved heat resistance performance.

Meanwhile, the technical problems to be solved by the present disclosure are not limited to the above-mentioned problems, and other unmentioned problems will be clearly understood by those skilled in the art from the description of the invention described below.

A battery assembly according to one embodiment of the present disclosure includes: a plurality of battery cells stacked along one direction; and a barrier disposed between the plurality of battery cells, and the barrier may include a base plate, and a first metal sheet inserted into the base plate.

The first metal sheet may have a plurality of holes.

The first metal sheet may have a mesh structure.

The base plate may include a polyurethane material or a silicone material.

The first metal sheet may include a copper material or an aluminum material.

The first metal sheet and the base plate may be joined by insert molding.

The barrier may further include a cover coupled to the outer surface of the base plate.

The cover may include a second metal sheet.

The second metal sheet may include a copper material or an aluminum material.

The cover may include an insulating sheet provided on the outer surface of the second metal sheet and has electrical insulation.

A battery assembly according to another embodiment of the present disclosure includes: a plurality of battery cells stacked along one direction; and a barrier disposed between the plurality of battery cells. In the battery assembly, the barrier includes a base plate, and a base cover coupled to the outer surface of the base plate. The base plate may be formed of a material having thermal insulation performance, and the base cover may include a material having a metal component, and an insulating sheet surrounding this material.

The base plate may include a polyurethane material or a silicone material.

The base plate may include a metal sheet inserted therein.

The metal sheet may have a mesh structure.

The metal component of the base cover may include an aluminum or copper material, and the insulating sheet may include a polyethylene terephthalate (PET), mica or glass fiber material.

A vehicle according to an aspect of the present disclosure includes a battery assembly of the present disclosure.

According to at least one of embodiments of the present disclosure, heat propagation between battery modules or battery cells may be suppressed.

According to at least one of embodiments of the present disclosure, the thermal stability of the battery assembly may be improved.

### BRIEF DESCRIPTION OF THE DRAWINGS

The following drawings attached hereto illustrate embodiments of the present disclosure and serve to further understand the technical idea of the present disclosure together with the content of the disclosure described above. Therefore, the present disclosure should not be construed as being limited to the matters illustrated in the drawings.

FIG. 1 is a view illustrating a battery module according to one embodiment of the present disclosure.

FIG. 2 is a view of the battery module of FIG. 1, in which some of the components are disassembled.

FIG. 3 is a view illustrating a barrier of FIG. 2.

FIG. 4 is a view of the barrier of FIG. 3, in which some of the components are disassembled.

FIG. 5 is a view illustrating a cross-sectional configuration taken along the cutting line B-B' in FIG. 3.

FIG. 6 is a view illustrating a cross-sectional configuration taken along the cutting line C-C' in FIG. 3.

FIG. 7 is a view illustrating a cross-sectional configuration taken along the cutting line D-D' in FIG. 3.

FIG. 8 is a view illustrating a cross-sectional configuration taken along the cutting line A-A' in FIG. 1.

FIG. 9 is a view of a battery pack according to one embodiment of the present disclosure, in which some of the components are disassembled.

FIG. 10 is a view illustrating the battery pack according to one embodiment of the present disclosure.

FIG. 11 is a view illustrating a vehicle according to one embodiment of the present disclosure.

Corresponding reference characters indicate corresponding components throughout the several views of the drawings. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

Hereinafter, embodiments of the present disclosure will be described in detail with reference to accompanying drawings. Prior to this, terms or words used in the present specification and claims should not be limitedly construed as usual or dictionary meanings, and should be interpreted as meanings and concepts consistent with the technical idea of the present disclosure on the basis of the principle that the inventor can appropriately define the concept of the term in order to explain his/her own invention in the best way.

Therefore, the embodiment described in this specification and the configurations illustrated in drawings are merely examples of the present disclosure, and do not represent all of technical ideas of the present disclosure. Thus, it should be understood that there may be various equivalents and modifications that can replace them at the time of filing this application.

In the present specification, a battery assembly may be used as a general term for both a battery module and a battery pack. The battery assembly may refer to a battery module or a battery pack.

According to one embodiment of the present disclosure, provided is a battery assembly capable of suppressing the propagation of a thermal event when the thermal event occurs.

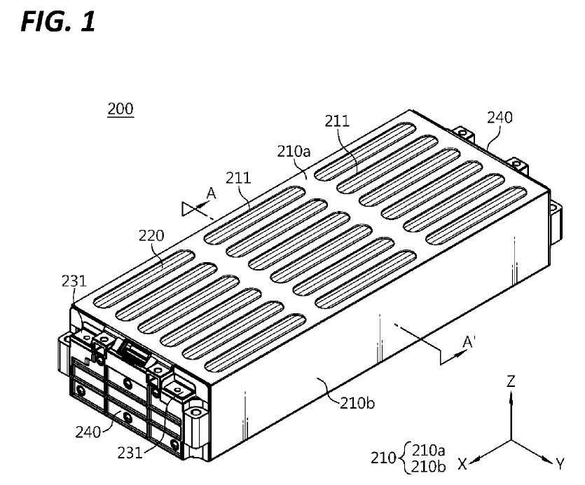

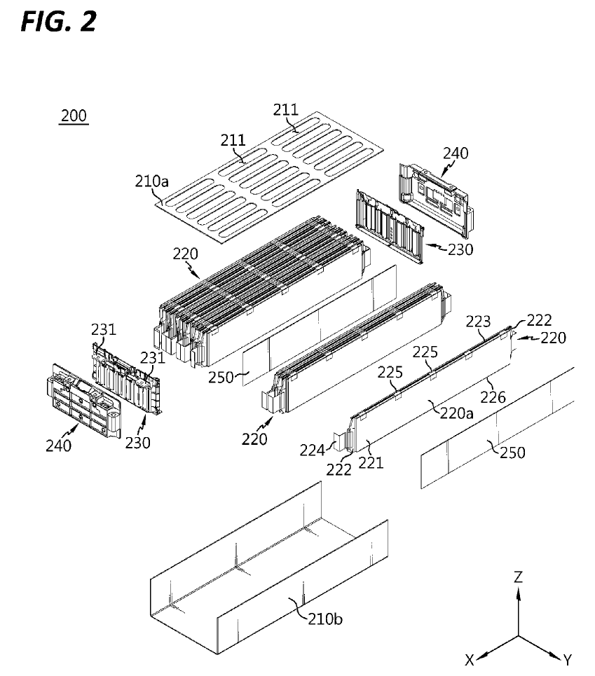

FIG. 1 is a view illustrating a battery module 200 according to one embodiment of the present disclosure. FIG. 2 is a view of the battery module 200 of FIG. 1, in which some of the components are disassembled.

Referring to FIG. 1 and FIG. 2, the battery module 200 according to one embodiment of the present disclosure may include a module frame 210. The module frame 210 may include a top plate 210a and a lower frame 210b. The module frame 210 may provide a space therein. The lower frame 210b may include a bottom plate and a pair of side plates. The top plate 210a may be joined, installed, fastened, coupled, fixed, or attached to the pair of side plates of the lower frame 210b. For example, the top plate 210a may be welded to the pair of side plates of the lower frame 210b. The module frame 210 may have a form with open front and rear sides. The top plate 210a may have a venting hole 211. The venting hole 211 may be provided on the upper surface of the module frame 210, for example, the top plate 210a. Through the venting hole 211, the inside and the outside of the module frame 210 may communicate with each other. A plurality of venting holes 211 may be provided.

The battery module 200 may include a battery cell 220. The battery cell 220 may refer to a secondary battery. According to one embodiment, the battery cell 220 may be a pouch-type secondary battery. However, the shape of the battery cell 220 is not limited to a pouch shape, and various shapes such as a cylindrical shape or a rectangular shape may be employed. A plurality of battery cells 220 may be provided. The battery cells 220 may be accommodated within the module frame 210.

When a thermal event occurs, venting gas or high-temperature particles may be emitted from the plurality of battery cells 220. The venting gas or high-temperature particles may be emitted to the outside of the battery module 200 via the venting holes 211.

The battery cell 220 may extend along the front-rear direction or the X-axis direction. The battery cells 220 may be stacked along the left-right direction or the Y axis direction. The battery cell 220 may include a cell case 220a that provides a space therein. The cell case 220a may include a housing portion 221 including an electrode assembly, a first sealing portion 222 protruding toward each of the front side and the rear side of the housing portion 221, and a second sealing portion 223 protruding upward from the housing portion 221. The first sealing portion 222 and the second sealing portion 223 may be formed through bonding or attachment to the cell case 220a. The lower end of the housing portion 221 may be referred to as a folding portion 226. The folding portion 226 may be formed through folding of the cell case 220a. Also, the battery cell 220 may include electrode leads 224 protruding toward the front side and the rear side of the first sealing portions 222, respectively. The electrode leads 224 may protrude toward the front side and the rear side of each housing portion 221. The battery cell 220 may include an adhesive member 225 by which the second sealing portion 223 is folded and fixed to the housing portion 221. The adhesive member 225 may cause the second sealing portion 223 to come in close contact with the housing portion 221. A plurality of adhesive members 225 may be provided. The adhesive members 225 may be arranged along the front-rear direction or the X-axis direction.

A barrier 250 may be disposed between the battery cells 220. The barrier 250 may be disposed between at least some of the battery cells 220 and/or outside a stack. For example, in the configuration form of the barrier 250, the barrier 250 may be disposed between every four battery cells 220 stacked in the left-right direction.

Such a barrier 250 may include an elastic material so that swelling of the battery cells 220 can be absorbed. For example, the barrier 250 may include a foam material such as polyurethane. Otherwise, the barrier 250 may include a material capable of blocking heat, flames, and the like. For example, the barrier 250 may include a thermal insulating or fire-proof material such as silicone or mica.

A front busbar frame assembly 230 may be provided in front of the plurality of battery cells 220. The front busbar frame assembly 230 may be electrically connected to the electrode leads 224 on the front side of the battery cells 220. The front busbar frame assembly 230 may include a power terminal 231.

A rear busbar frame assembly 230 may be provided at the rear of the plurality of battery cells 220. The rear busbar frame assembly 230 may be electrically connected to the electrode leads 224 on the rear side of the battery cells 220.

A pair of end covers 240 may be coupled to the front side and the rear side of the module frame 210, respectively. The pair of end covers 240 may cover the front side and the rear side of the module frame 210. The end cover 240 may have a rectangular shape. The pair of end covers 240 may form the exterior of the battery module 200. The front end cover 240 may cover the front busbar frame assembly 230. The rear end cover 240 may cover the rear busbar frame assembly 230.

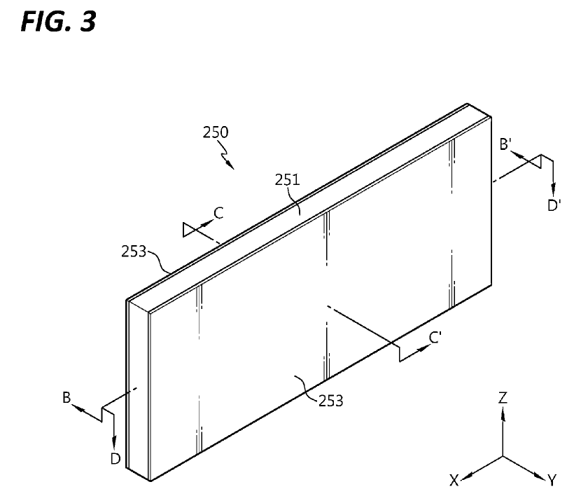

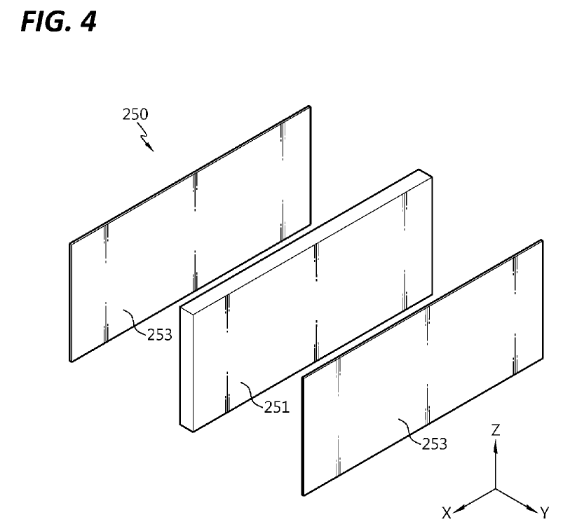

FIG. 3 is a view illustrating the barrier 250 according to one embodiment of the present disclosure. FIG. 4 is a view of the barrier 250 of FIG. 3, in which some of the components are disassembled.

Referring to FIG. 3 and FIG. 4, the barrier 250 may have a rectangular parallelepiped shape. The barrier 250 may include a base plate 251. The base plate 251 may have a rectangular shape. The base plate 251 may include an elastic material. The base plate 251 may include a material having high thermal insulation. The base plate 251 may include a material having high fire resistance. The base plate 251 may include a material having high heat resistance. For example, the base plate 251 may include a silicone material. For example, the base plate 251 may include a polyurethane material.

The barrier 250 may include a base cover 253. The base cover 253 may be fastened, coupled, fixed, or attached to the base plate 251. The base cover 253 may be provided on the outer surface of the base plate 251. A pair of base covers 253 may be provided. The pair of base covers 253 may be provided on the left surface and the right surface of the base plate 251, respectively. The base plate 251 may be disposed between the pair of base covers 253.

The base cover 253 may have a rectangular shape. The base cover 253 may have a sheet shape. The base cover 253 may include a material having high thermal insulation. The base cover 253 may include a material having high fire resistance. The base cover 253 may include a material having high heat resistance. The base cover 253 may include a material having electrical insulation. For example, the base cover 253 may include a polyethylene terephthalate (PET) material. For example, the base cover 253 may include a mica material. For example, the base cover 253 may include a glass fiber material.

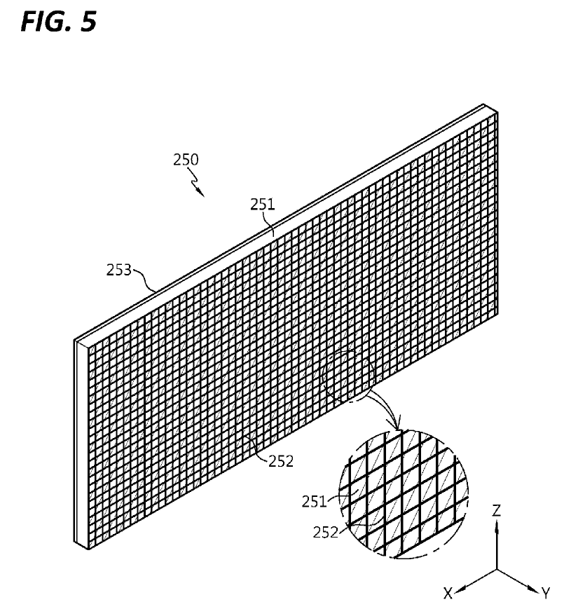

FIG. 5 is a view illustrating a cross-sectional configuration taken along the cutting line B-B' in FIG. 3.

Referring to FIG. 5, the barrier 250 may include a first metal sheet 252. According to one embodiment, the first metal sheet 252 may be located inside the base plate 251. For example, the first metal sheet 252 may be inserted into the base plate 251. Meanwhile, the location of the first metal sheet 252 is not limited to the interior of the base plate 251. For example, as necessary, the first metal sheet 252 may be configured to surround the outside of the base plate 251.

The first metal sheet 252 may have a high thermal conductivity. The first metal sheet 252 may quickly diffuse the heat locally applied to the base plate 251. For example, the first metal sheet 252 may include an aluminum material. For example, the first metal sheet 252 may include a copper material.

The first metal sheet 252 may improve thermal insulation performance of the base plate 251 by quickly diffusing the heat applied to the base plate 251. The first metal sheet 252 may improve the heat resistance performance of the base plate 251 by quickly diffusing the heat applied to the base plate 251. The first metal sheet 252 may improve the fire resistance performance of the base plate 251 by quickly diffusing heat applied to the base plate 251. The first metal sheet 252 may make the temperature distribution of the base plate 251 uniform by quickly diffusing the heat applied to the base plate 251. The first metal sheet 252 may cool the base plate 251 by quickly diffusing the heat applied to the base plate 251. The first metal sheet 252 may improve the performance of the barrier 250.

Due to the performance improvement of the barrier 250, the propagation of a thermal event occurring in the battery module 200 may be suppressed. Also, the thermal stability of the battery module 200 may be improved.

According to one embodiment, the first metal sheet 252 and the base plate 251 may be joined by insert molding. The first metal sheet 252 and the base plate 251 may be joined by an over-molding.

The first metal sheet 252 may have a plurality of holes. The base plate 251 may fill the holes of the first metal sheet 252. Since the holes of the first metal sheet 252 are filled by the base plate 251, the bonding strength between the base plate 251 and the first metal sheet 252 may be increased. By having the plurality of holes, the first metal sheet 252 may be stably joined to the base plate 251. For example, the first metal sheet 252 may have a mesh structure.

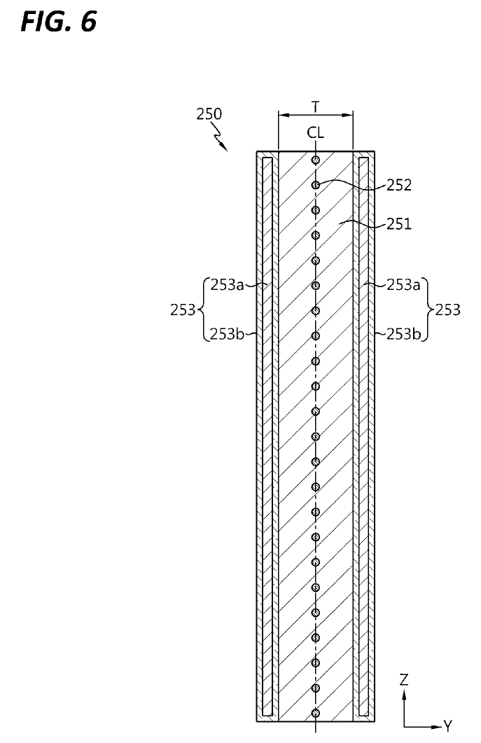

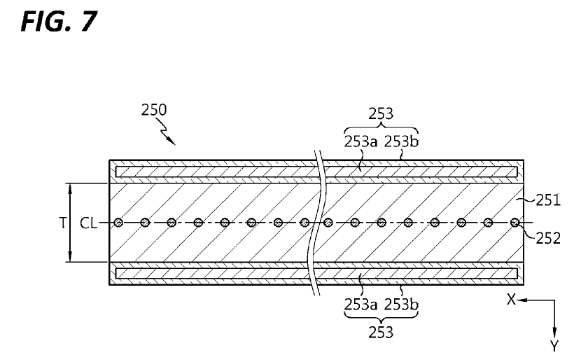

FIG. 6 is a view illustrating a cross-sectional configuration taken along the cutting line C-C' in FIG. 3. FIG. 7 is a view illustrating a cross-sectional configuration taken along the cutting line D-D' in FIG. 3.

Referring to FIG. 6 and FIG. 7, the base plate 251 may have a thickness T in the Y-axis direction or the left-right direction. According to one embodiment, the first metal sheet 252 may be disposed at the center line CL of the thickness T of the base plate 251. Accordingly, the first metal sheet 252 may make the temperature distribution of the base plate 251 more uniform.

The base cover 253 may include a second metal sheet 253a. The second metal sheet 253a may have a high thermal conductivity. The second metal sheet 253a may quickly diffuse the heat locally applied to the base cover 253. For example, the second metal sheet 253a may include an aluminum material. For example, the second metal sheet 253a may include a copper material.

The second metal sheet 253a may lower the temperature of the heat to be transferred to the base plate 251 by quickly diffusing the heat applied to the base cover 253. The second metal sheet 253a may improve the heat resistance performance of the barrier 250 by quickly diffusing the heat applied to the base cover 253. The second metal sheet 253a may improve the fire resistance performance of the barrier 250 by quickly diffusing the heat applied to the base cover 253. The second metal sheet 253a may make the temperature distribution of the base plate 251 uniform by quickly diffusing the heat applied to the base cover 253. The second metal sheet 253a may lower the temperature of heat to be transferred to the battery cell 220 by quickly diffusing the heat applied to the base cover 253. The second metal sheet 253a may improve the performance of the barrier 250.

Due to the performance improvement of the barrier 250, the propagation of a thermal event may be suppressed. Also, the thermal stability of the battery module 200 may be improved.

The base cover 253 according to one embodiment of the present disclosure may include an insulating sheet 253b. The insulating sheet 253b may be installed, joined, coupled, attached, or fixed to the outer surface of the second metal sheet 253a. The insulating sheet 253b may be configured to surround the second metal sheet 253a. The insulating sheet 253b may improve the electrical safety of the barrier 250. Meanwhile, the location of the insulating sheet 253b is not limited to the outer surface of the second metal sheet 253a. For example, as necessary, the insulating sheet 253b may also be formed on the inner surface of the second metal sheet 253a.

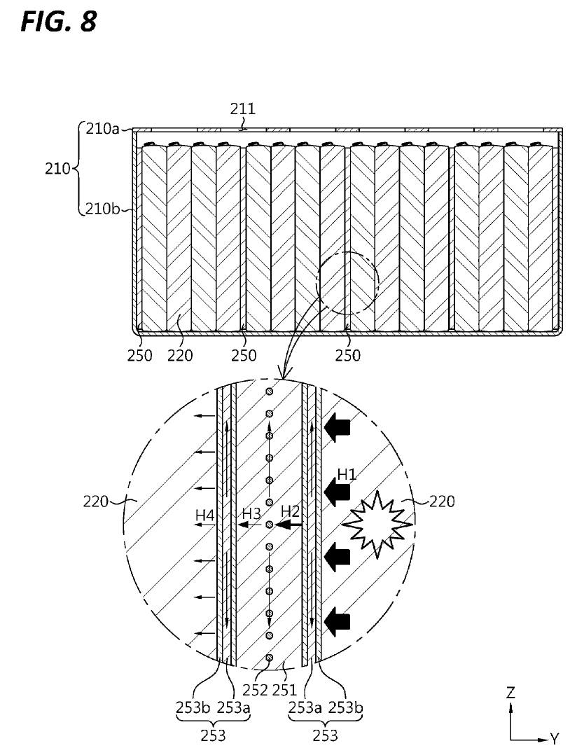

FIG. 8 is a view illustrating a cross-sectional configuration taken along the cutting line A-A' in FIG. 1.

Referring to FIG. 8, when a thermal event occurs or heat is generated in the battery cell 220 according to one embodiment of the present disclosure, the heat may be transferred to an adjacent battery cell 220. The first heat H1 generated on the right side of the barrier 250 may be transferred to the right base cover 253 of the barrier 250. The first heat H1 transferred to the right base cover 253 of the barrier 250 may be quickly conducted or diffused by the second metal sheet 253a. The second heat H2 to be transferred to the base plate 251 may be transferred at a lower temperature than the first heat H1 due to the second metal sheet 253a. The second heat H2 transferred to the base plate 251 may be quickly conducted or diffused by the first metal sheet 252. The third heat H3 to be transferred to the left base cover 253 of the barrier 250 may be transferred at a lower temperature than the second heat H2 due to the first metal sheet 252. The third heat H3 transferred to the left base cover 253 of the barrier 250 may be quickly conducted or diffused by the second metal sheet 253a. The fourth heat H4 to be transferred to the battery cell 220 located on the left side of the barrier 250 may be transferred at a lower temperature than the third heat H3 due to the second metal sheet 253a.

In this manner, since the barrier 250 includes the first metal sheet 252, it is possible to significantly lower the temperature of the fourth heat H4 compared to the temperature of the first heat H1. Also, since the barrier 250 includes the second metal sheet 253a, it is possible to significantly lower the temperature of the fourth heat H4 compared to the temperature of the first heat H1.

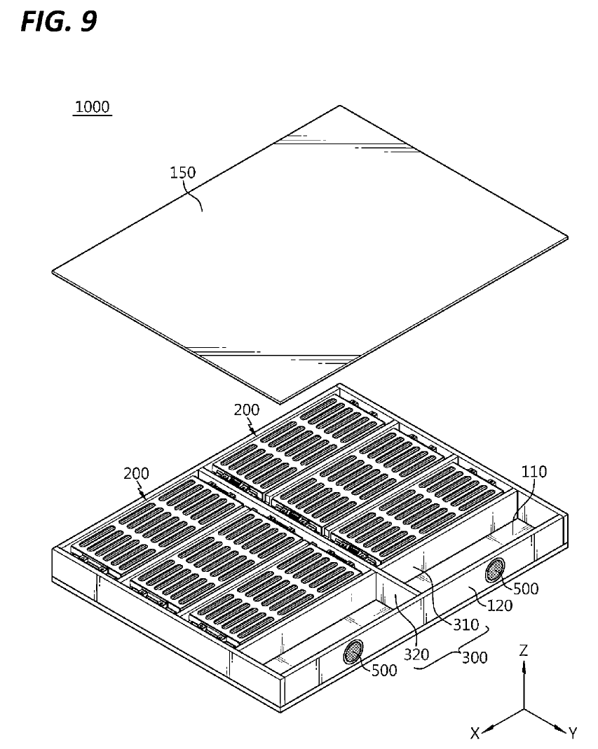

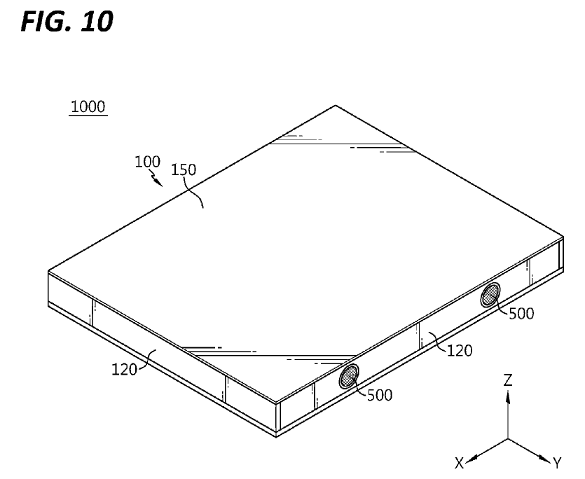

FIG. 9 is a view of a battery pack 1000 according to one embodiment of the present disclosure, in which some of the components are disassembled. FIG. 10 is a view illustrating the battery pack 1000 according to one embodiment of the present disclosure.

Referring to FIG. 9 and FIG. 10, the battery pack 1000 according to one embodiment of the present disclosure may include a pack case 100. The pack case 100 may form the exterior of the battery pack 1000. The pack case 100 may have a rectangular parallelepiped shape. The pack case 100 may provide a space therein. The pack case 100 may include a pack cover 150. The pack cover 150 may have a rectangular-plate shape. The battery module 200 may be located inside the pack case 100.

The pack case 100 may include a base plate 110. The base plate 110 may have a rectangular shape. The base plate 110 may have a flat-plate shape. The base plate 110 may form the exterior of the battery pack 1000. The base plate 110 may provide an internal space of the battery pack 1000.

The pack case 100 may include a side wall 120. The side wall 120 may be installed, fastened, coupled, fixed, or attached to the upper surface of the base plate 110. The side wall 120 may be provided as four walls. The side wall 120 may be disposed along the perimeter of the base plate 110. The side wall 120 may form the exterior of the battery pack 1000. The side wall 120 may provide an internal space.

The pack cover 150 may be installed, fastened, coupled, fixed, or attached to the side wall 120. The pack cover 150 may cover the internal space of the battery pack 1000.

The battery pack 1000 may include a venting device 500. The venting device 500 may be provided on the side wall 120. For example, the venting device 500 may be provided on the front side wall 120. For example, the venting device 500 may be a gas valve. When the pressure inside the pack case 100 increases, the venting device 500 may be opened to discharge gas. Also, the venting device 500 may block the external air from flowing into the pack case 100. A plurality of venting devices 500 may be provided.

The battery pack 1000 may include a partition wall 300. The partition wall 300 may include a first partition wall 310 and a second partition wall 320. A plurality of partition walls 300 may be provided. The partition wall 300 may be installed, fastened, fixed, coupled, or attached to the upper surface of the base plate 110. The partition wall 300 may partition the internal space of the battery pack 1000. The battery modules 200 may be located in spaces defined by the partition walls 300.

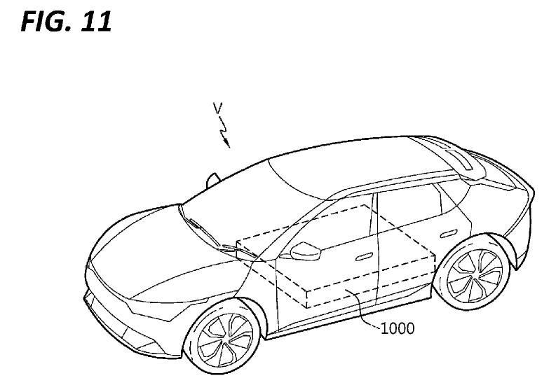

FIG. 11 is a view illustrating a vehicle V, according to one embodiment of the present disclosure.

Referring to FIG. 11, the vehicle V, according to the present disclosure, may include the battery pack 1000 of the present disclosure.

Also, the battery pack 1000, according to the present disclosure, may further include various components other than the battery module 200, for example, various battery pack components known at the time of filing of this invention, such as a BMS, a busbar, a relay, and a current sensor.

The battery pack 1000, according to the present disclosure, may be applied to a vehicle such as an electric vehicle or a hybrid vehicle. The vehicle V, according to the present disclosure, may further include various other components included in the vehicle, in addition to such a battery pack 1000. For example, the vehicle V, according to the present disclosure, may further include a vehicle body, a motor, a control device such as an electronic control unit (ECU), etc.

Meanwhile, although terms indicating directions, such as up, down, left, right, front, and back, have been used in the present specification, it is obvious to those skilled in the art of the present disclosure that these terms are only for convenience of explanation and may vary depending on the location of a target object, the location of an observer, etc.

As described above, although the present disclosure has been described by limited embodiments and drawings, the present disclosure is not limited thereto. It is obvious that various modifications and changes can be made within the scope of the technical idea of the present disclosure and the equivalent scope of the patent claims to be described below, by a person having ordinary knowledge in the technical field to which the present disclosure pertains.

What is claimed is:

1. A battery assembly comprising:
a plurality of battery cells stacked along one direction; and
a barrier disposed between the plurality of battery cells,
wherein the barrier includes a base plate, and a first metal sheet inserted into the base plate.

2. The battery assembly according to claim 1, wherein the first metal sheet includes a plurality of holes.

3. The battery assembly according to claim 1, wherein the first metal sheet has a mesh structure.

4. The battery assembly according to claim 1, wherein the base plate includes a polyurethane material or a silicone material.

5. The battery assembly according to claim 1, wherein the first metal sheet includes a copper material or an aluminum material.

6. The battery assembly according to claim 1, wherein the first metal sheet and the base plate are joined by insert molding.

7. The battery assembly according to claim 1, wherein the barrier further includes a base cover coupled to an outer surface of the base plate.

8. The battery assembly according to claim 7, wherein the base cover includes a second metal sheet.

9. The battery assembly according to claim 8, wherein the second metal sheet includes a copper material or an aluminum material.

10. The battery assembly according to claim 8, wherein the base cover includes an insulating sheet provided on an outer surface of the second metal sheet and having electrical insulation.

11. A battery assembly comprising:
a plurality of battery cells stacked along one direction; and
a barrier disposed between the plurality of battery cells,
wherein the barrier includes a base plate, and a base cover coupled to the outer surface of the base plate,
the base plate is formed of a material having thermal insulation performance, and
the base cover includes a material having a metal component, and an insulating sheet surrounding this material.

12. The battery assembly according to claim 11, wherein the base plate includes a polyurethane material or a silicone material.

13. The battery assembly according to claim 11, wherein the base plate includes a metal sheet inserted therein.

14. The battery assembly according to claim 13, wherein the metal sheet has a mesh structure.

15. The battery assembly according to claim 11, wherein the metal component of the base cover includes an aluminum or copper material, and
the insulating sheet includes a polyethylene terephthalate (PET), mica or glass fiber material.

16. A vehicle comprising the battery assembly according to claim 1.
